(19) United States
(12) Patent Application Publication
(10) Pub. No.: US 2014/0325449 A1
(43) Pub. Date: Oct. 30, 2014

(54) METHOD, DEVICE AND STORAGE MEDIUM FOR STARTING APPLICATION IN ELECTRONIC APPARATUS

(71) Applicant: TENCENT TECHNOLOGY (SHENZHEN) COMPANY LIMITED, Shenzhen City (CN)

(72) Inventor: JIE-JUN LONG, Shenzhen City (CN)

(73) Assignee: TENCENT TECHNOLOGY (SHENZHEN) COMPANY LIMITED, Shenzhen City (CN)

(21) Appl. No.: 14/262,788

(22) Filed: Apr. 27, 2014

Related U.S. Application Data
(63) Continuation of application No. PCT/CN2013/088724, filed on Dec. 6, 2013.

(30) Foreign Application Priority Data
Apr. 28, 2013 (CN) 201310155883.9

(51) Int. Cl. G06F 3/0482; G06F 3/0484; G06F 3/0481

(52) U.S. Cl. CPC G06F 3/0482; G06F 3/04817; G06F 3/04842
USPC 715/835

(57) ABSTRACT

Provided is a method and a device for starting application in an electronic apparatus. The method includes: displaying a contact list; detecting a first input operation associated with a target contact in the contact list; displaying an operation menu in response to the first input operation, wherein the operation menu comprising a plurality of menu items, each menu item corresponding to at least one application; detecting a second input operation associated with a target menu item in the menu items; and initiating an application startup request in response to the second input operation to start application corresponding to the target menu item, wherein the application startup request includes information of the target contact. The method and device can save time for users starting application.

### CROSS-REFERENCE

This application is a U.S. continuation application under 35 U.S.C. §111(a) claiming priority under 35 U.S.C. §120 and 365(c) to International Application No. PCT/CN2013/088724 filed Dec. 6, 2013, which claims the priority benefit of Chinese Patent Application No. 201310155883.9, filed on Apr. 28, 2013, the contents of which are incorporated by reference herein in their entirety for all intended purposes.

### FIELD OF THE INVENTION

The present disclosure relates to application interaction technology, particularly relates to a method and a device for starting application in electronic apparatus.

### BACKGROUND OF THE INVENTION

In recent years, a variety of electronic devices, such as smart phones, tablet PCs, laptops, etc., have been developed rapidly in both hardware performance and the richness of applications. People have become more dependent on these electronic devices to communicate with each other in their daily life and work.

For example, users can manage their own contact list by the contacts application. Through the application, users can send messages, make phone calls to different contacts, and view the saved information of other contacts such as address, birthday, etc. Users can also communicate with others by instant messaging applications. It is obviously that instant messaging applications also maintain a contact list generally. In current situation, the contact lists of the two applications are independent of each other.

Therefore, users have to remember, or remark in contact list the account number information of the contact in other application, and then associate with the contact by the remarked account number information. Based on the mechanism, while a user is using a first application, and he wants to communicate with a contact in the first application by a second application, the user needs to know the account number information of the contact in the second application, and then starts the second application, confirms the contact in the second application, and contacts; or the user needs to start the second application, and then finds out the contact whom he wants to contact with by the remarked account number information in the second application, and contacts.

However, it will take users quite long time to search and select the contact by either of the ways.

### SUMMARY OF THE INVENTION

The present disclosure provides a method and device for starting application in an electronic apparatus.

In one aspect, a method for starting application in electronic apparatus includes: display a contact list; detecting a first input operation associated with a target contact in the contact list; display an operation menu in response to the first input operation, wherein the operation menu comprising a plurality of menu items, each menu item corresponding to at least one application; detecting a second input operation associated with a target menu item in the menu items; and initiating an application startup request in response to the second input operation to start application corresponding to the target menu item, wherein the application startup request includes information of the target contact.

In another aspect, a device for starting application in an electronic apparatus includes: a first display module configured to display a contact list; a first detecting module configured to detect a first input operation associated with a target contact in the contact list; a second display module configured to display an operation menu in response to the first input operation, wherein the operation menu comprising a plurality of menu items, each menu item corresponding to at least one application; a second detecting module configured to detect a second input operation associated with a target menu item in the menu items; and an application startup module configured to initiate an application startup request in response to the second input operation to start application corresponding to the target menu item, wherein the application startup request includes information of the target contact.

A computer-readable storage medium storing instructions for starting application in an electronic apparatus, the instructions includes: display a contact list; detecting a first input operation associated with a target contact in the contact list; display an operation menu in response to the first input operation, wherein the operation menu comprising a plurality of menu items, each menu item corresponding to at least one application; detecting a second input operation associated with a target menu item in the menu items; and initiating an application startup request in response to the second input operation to start application corresponding to the target menu item, wherein the application startup request includes information of the target contact.

In accordance with the method and device for staring application in an electronic apparatus, users may directly start different application in a contact list, and transfer selected contact information to the application to be started. Therefore, the application to be started may be automatically configured according to the selected contact information, which reduces user operation and saves time for users.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a block diagram of an electronic apparatus;

FIG. 2 is a flow chart of an example of method for starting application in an electronic apparatus according to various embodiments;

FIG. 3 is a schematic illustration of a contact list in accordance with the method of FIG. 2;

FIG. 4 is an example of a gesture input based on touch-sensitive screen in accordance with the method of FIG. 2;

FIG. 5 is an exemplary operation menu in accordance with the method of FIG. 2;

FIG. 6 is an example of a gesture input based on touch-sensitive screen in accordance with the method of FIG. 2;

FIG. 7 is a schematic illustration of an application having been started in accordance with the method of FIG. 2;

FIG. 8 is a flow chart of another example of method for starting application in an electronic apparatus according to various embodiments;

FIG. 9 is a schematic illustration of the menu item shown in accordance with the method of FIG. 8;

FIG. 10 is a schematic illustration of an editing user interface of the associated account number information in accordance with the method of FIG. 8;

FIG. 11 is a flow chart of yet another example of method for starting application in an electronic apparatus according to various embodiments;

FIG. 12 is a flow chart of yet another example of method for starting application in an electronic apparatus according to various embodiments;

FIG. 13 is a schematic illustration of an Instant Messaging application having been started in accordance with the method of FIG. 12;

FIG. 14 is a flow chart of yet another example of method for starting application in an electronic apparatus according to various embodiments;

FIG. 15 is a block diagram of an example of device for starting application in an electronic apparatus according to various embodiments;

FIG. 16 is a schematic illustration of storage environment of the device illustrated in FIG. 15;

FIG. 17 is a block diagram of another example of device for starting application in an electronic apparatus according to various embodiments;

FIG. 18 is a block diagram of yet another example of device for starting application in an electronic apparatus according to various embodiments;

FIG. 19 is a block diagram of yet another example of device for starting application in an electronic apparatus according to various embodiments;

FIG. 20 is a block diagram of yet another example of device for starting application in an electronic apparatus according to various embodiments;

FIG. 21 is a block diagram of yet another example of device for starting application in an electronic apparatus according to various embodiments.

### DETAILED DESCRIPTION OF PREFERRED EMBODIMENTS

Various embodiments of the disclosure are discussed in detail below. While specific implementations are discussed, it should be understood that this is done for illustration purposes only. A person skilled in the art will recognize that other components and configurations may be used without parting from the spirit and scope of the disclosure.

The mentioned electronic devices, such as desktop computers, notebook computers, smart phones, personal digital assistants, tablet PCs, etc., install/run one or more smart operating system inside. The applications are software function modules, which are installed in the smart operating system and used to accomplish certain function.

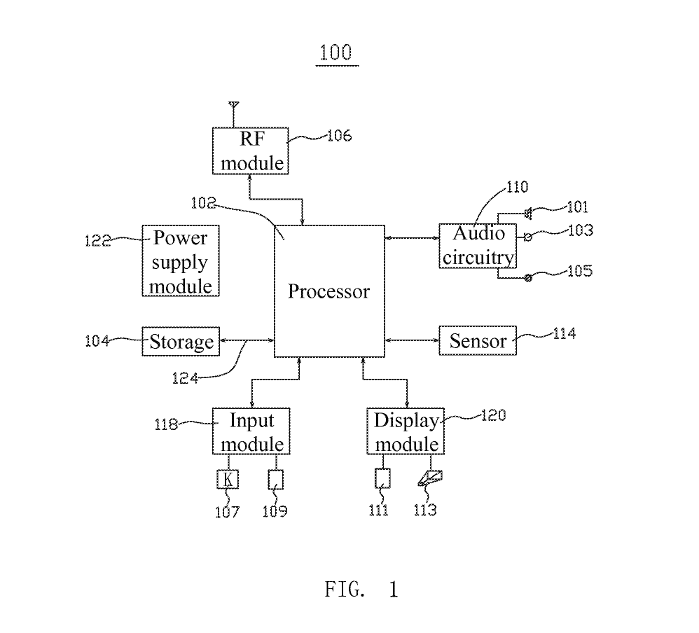

FIG. 1 illustrates an electronic apparatus example. Referring to FIG. 1, the electronic apparatus 100 includes one or more (only one in FIG. 1) processors 102, a storage 104, a Radio Frequency (RF) module 106, an Audio circuitry 110, a sensor 114, an input module 118, a display module 120, and a power supply module 122. A person skilled in the art will understand that the structure in FIG. 1 is shown for illustration purposes only, not limitations of the electronic apparatus 100. For example, the electronic apparatus 100 may also include more or less parts than FIG. 1 shows, or different configuration.

It can be understood by those skilled in the art that besides the processor 102, all other components are belong to peripheral. The processor 102 and the peripherals are coupled by many peripheral interfaces 124. Peripheral interfaces 124 may be implemented based on the following standards: Universal Asynchronous Receiver/Transmitter (UART), General Purpose Input Output (GPIO), Serial Peripheral Interface (SPI), Inter-Integrated Circuit (I2C), but not limited to the above standards. In some examples, the peripheral interfaces 124 may only include the bus; while in other examples, the peripheral interfaces 124 may also include other components, one or more controllers, for example, which may be a display controller for connecting a liquid crystal display panel or a storage controller for connecting storage. In addition, these controllers may also be separated from the peripheral interface 124, and integrated inside the processor 102 or the corresponding peripheral.

The storage 104 may be used to store software programs and modules, such as the program instructions/modules corresponding to the method and device of starting applications in an electronic apparatus in the present disclosure. The processor 102 performs a variety of functions and data processing by running the software program and the module stored in the memory 104, which implements the above method of starting applications in the electronic apparatus. Memory 104 may include high-speed random access memory and nonvolatile memory, such as one or more magnetic storage devices, flash memory, or other non-volatile solid-state memory. In some examples, the memory 104 may further include a remote configured memory compared to the processor 102, which may be connected to the electronic apparatus 100 via the network. The network instances include but not limited to, the Internet, intranets, local area network, mobile communication network, and their combinations.

The RF module 106 is used for receiving and transmitting electromagnetic waves, implementing the conversion between electromagnetic waves and electronic signals, and communicating with the communication network or other devices. The RF module 106 may include a variety of existing circuit elements, which perform functions, such as antennas, RF transceivers, digital signal processors, encryption/decryption chips, the subscriber identity module (SIM) card, memory, etc. The RF module 106 may communicate with a variety of networks such as the Internet, intranets, wireless network and communicate to other devices via wireless network. The above wireless network may include a cellular telephone network, wireless local area network (LAN) or metropolitan area network (MAN). The above wireless network may use a variety of communications standards, protocols and technologies, including but not limited to Global System for Mobile Communication (GSM), Enhanced Data GSM Environment (EDGE), wideband code division multiple access (W-CDMA), Code division access (CDMA), time division multiple access (TDMA), Wireless, Fidelity (WiFi) (such as the American Institute of Electrical and Electronics Engineers Association standards IEEE 802.11a, IEEE 802.11b, IEEE802.11g, and/or IEEE 802.11n), Voice over internet protocol (VoIP), Worldwide Interoperability for Microwave Access (Wi-Max), other protocols used for mail, instant messaging and short message, as well as any other suitable communication protocol, even including the protocols which are not yet been developed currently.

The Audio circuitry 110, the speaker 101, the audio jack 103, the microphone 105 together provide the audio interface between the user and the electronic device 100. Specifically, the audio circuit 110 receives audio data from the processor 102, converts the audio data into an electrical signal, and transmits the signal to the speaker 101. The speaker 101 converts the electrical signals to sound waves which may be heard by human ears. The audio circuitry 110 also receives electronic signals from the microphone, converts electronic signals to audio data, and transmits the audio data to the processor 102 for further processing. The audio data may also be acquired from the memory 104 or the RF module 106, the transmission module 108. In addition, the audio data may also be stored in the memory 104 or transmitted by the RF module 106 and the transmission module 108.

Examples of sensor 114 include but not limited to: an optical sensor, an operating sensor, and other sensors. Specifically, the optical sensor may include an ambient light sensor and a proximity sensor. The ambient light sensor may sense ambient light and shade, and then some modules executed by the processor 102 may use the output of the ambient light sensor to automatically adjust the display output. The proximity sensor may turn off the display output when detect the electronic device 100 near the ear. As a kind of motion sensor, gravity sensor may detect the value of acceleration in each direction (typically triaxiality), and the value and direction of gravity when the gravity sensor keeps still, which may be used for applications to identify the phone posture (such as horizontal and vertical screen switching, related games, magnetometer posture calibration), and for vibration recognition related functions (such as pedometer, percussion), etc. The electronic device 100 may also include a gyroscope, a barometer, a hygrometer, a thermometer, and other sensors, which is not shown for the purpose of brevity.

The input unit 118 may be configured to receive the input character information, and to generate input by keyboard, mouse, joystick, optical or trackball signal related to user settings and function control. Specifically, the input unit 130 may include button 107 and touch surface 109. The buttons 107 for example, may include character buttons for inputting characters, and control buttons for triggering control function. The instances of the control buttons may include a “back to the main screen” button, a power on/off button, a camera button, and so on. The touch surface 109 may collect user operation on or near it (for example, a user uses a finger, a stylus, and any other suitable object or attachment to operate on or near the touch surface 109), and drive the corresponding connecting device according to pre-defined program. Optionally, the touch surface 109 may include a touch detection device and a touch controller. The touch detection device detects users' touch position and a signal produced by the touch operation, and passes the signal to the touch controller. The touch controller receives touch information from the touch detection device, converts the touch information into contact coordinates, sends the contact coordinates to the processor 102, and receives and executes commands sent from the processor 102. In addition, the touch surface 109 may be implemented in resistive, capacitive, infrared, surface acoustic wave and other forms. Besides the touch surface 109, the input unit 118 may also include other input devices. The preceding other input devices include but not limited to, one or more physical keyboards, trackballs, mouse, joysticks, etc.

The display module 120 is configured to display the information input by users, the information provided to users, and a variety of graphical user interfaces of the electronic device 100. The graphical user interfaces may consist of graphics, text, icons, video, and any combination of them. In one example, the display module 120 includes a display panel 111. The display panel 111 may for example be a Liquid Crystal Display (LCD) panel, an Organic Light-Emitting Diode Display (OLED) panel, an Electro-Phoretic Display (EPD) panel and so on. Furthermore, the touch surface 109 may be on top of the display panel 111 as a whole. In other embodiments, the display module 120 may also include other types of display devices, such as a projection display device 113. Compared with the general display panel, the projection display device 113 needs to include a plurality of components for projection, such as a lens group.

The power supply module 122 is used to provide power for the processor 102 and other components. Specifically, the power supply module 122 may include a power management system, one or more power supplies (such as a battery or AC), a charging circuit, a power failure detection circuit, an inverter, a power status indicator, and any other components related to electricity generation, management and distribution within the electronic device 100.

### First Embodiment

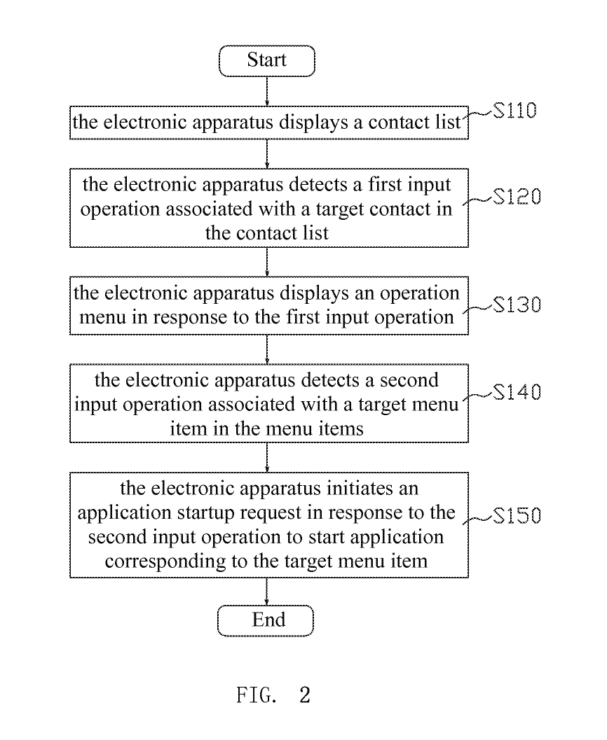

Referring to FIG. 2, which is a flow chart of a method for starting application in an electronic apparatus provided by a first embodiment of the present disclosure. The method includes the following steps:

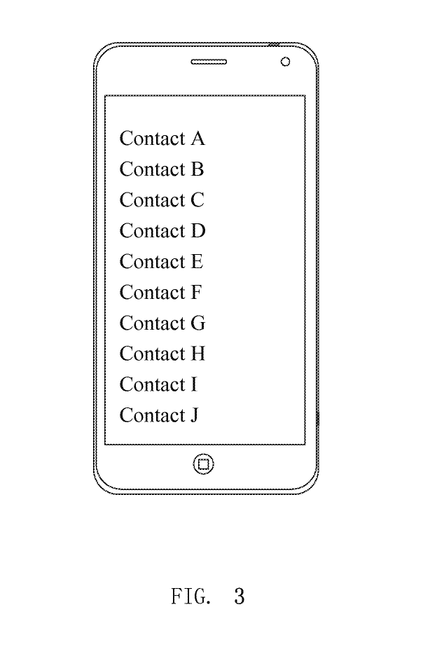

In step 110, the electronic apparatus displays a contact list. Contact information may be stored in the storage unit 104 as FIG. 1 shows. Each contact information may include, for example, phone number(s), a name, address(es), instant messaging application account, bank account, or other possible information associated with the contact. The contact list may show one or more of these fields. FIG. 3 illustrates an example of a contact list, wherein the contact list shows contact names. In the contact list shown in FIG. 3, each item represents one contact.

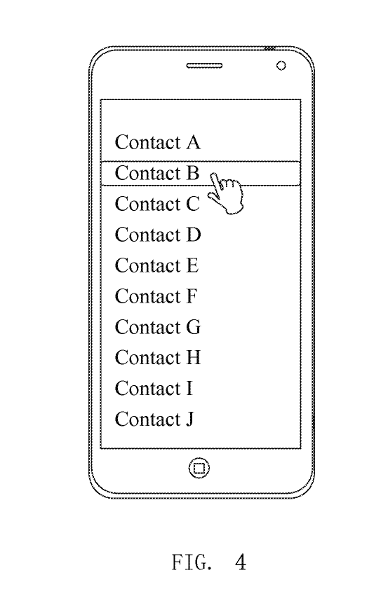

In step 120, the electronic apparatus detects a first input operation associated with a target contact in the contact list. The first input operation for example is input via the input module shown in FIG. 1. In detail, the operation may include any number of input mechanisms, such as keyboard, a gesture or graphical input based on touch-sensitive screen, voice commands, and so forth. FIG. 4 illustrates a gesture input based on touch-sensitive screen, that is, a user uses an object (e.g., a finger) to touch the menu item where “contact B” locates.

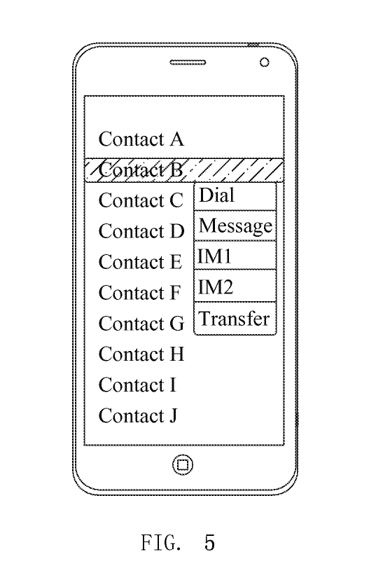

In step 130, the electronic apparatus displays an operation menu in response to the first input operation. The operation menu includes a plurality of menu items. Each menu item corresponds to at least one application. The preceding touch operation is received by input unit 118. The input unit 118 calculates coordinate of the contact and transfers the coordinate to the process 102. During the process, the touch operation triggers a click invent. Accordingly, the process 102 executes the step of representing the operation menu. FIG. 5 illustrates an exemplary operation menu. Referring to FIG. 5, the operation menu includes a plurality of menu items. Their names are “dial,” “message,” “IM 1,” “IM 2,” and “transfer.” These names illustrate their functions, wherein “message” means send a message, “transfer” means transfer account. Each item is corresponding to one or more application. Wherein, IM means Instant Messaging application.

In the example shown in FIG. 5, the shown operation menu is level 1 menu, that is, each menu item is corresponding to one application. However, understandably, the present embodiment is not so limited. For example, the operation menu may be multi-level menu. Some operation menu (parent menu) item may include child menu item (s). The parent menu item may show/hide the child menu item according to user's operation, but not trigger application startup itself. In multi-level menu, parent menu is corresponding to one or more child menu items, which means corresponding to one or more applications.

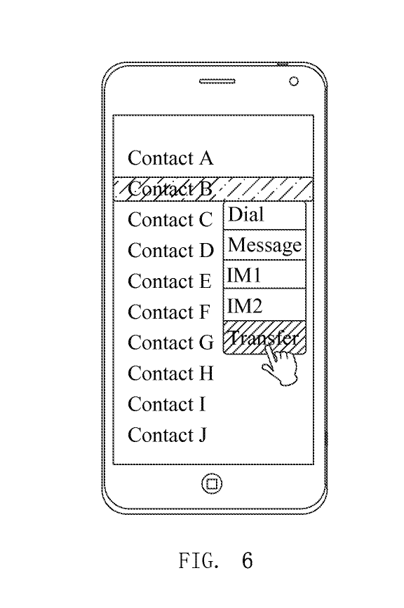

In step 140, the electronic apparatus detects a second input operation associated with a target menu item in the menu items. The second input operation for example is input via the input module shown in FIG. 1. In detail, the operation may include any number of input mechanisms, such as keyboard, a gesture or graphical input based on touch-sensitive screen, voice commands, and so forth. FIG. 6 illustrates a gesture input based on touch-sensitive screen, that is, users may use an object (such as a finger) to touch the menu item where “Transfer” locates.

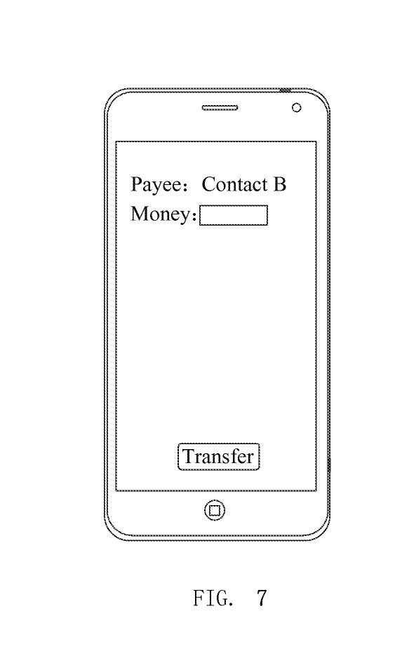

In step 150, the electronic apparatus initiates an application startup request in response to the second input operation to start application corresponding to the target menu item. The preceding touch operation (the second input operation) is received by input unit 118. The input unit 118 calculates coordinate of the contact and transfers the coordinate to the process 102. During the process, the touch operation triggers a click invent. Accordingly, the processor 102 initiates an application startup request to start the application corresponding to the target menu item. In all kinds of intelligent operating system, starting an installed application by interface provided by the system may be easily recognized by those skilled in the art. In the touch operation illustrated in FIG. 6, the user clicks “transfer account.” Referring to FIG. 7, transfer account application startups, and the user may transfer account directly by the transfer account application.

In the operation shown in FIG. 6, the user has selected contact B, therefore in the transfer account application shown in FIG. 7, the recipient may be directly set as contact B. It is unnecessary to set the recipient in the transfer account application again. Understandably, to achieve this purpose, the contact information in the contact list selected by the user needs to be passed to the transfer account application shown in FIG. 7, that is, the application startup request includes information of the target contact. Transferring information in the same application or between different applications may be easily recognized by those of skill in the art.

In the exemplary embodiments of the present disclosure, users may directly start different application in a contact list, and transfer selected contact information to the application to be started. Therefore, the application to be started may be automatically configured according to the selected contact information, which reduces user operation and saves time for users.

### Second Embodiment

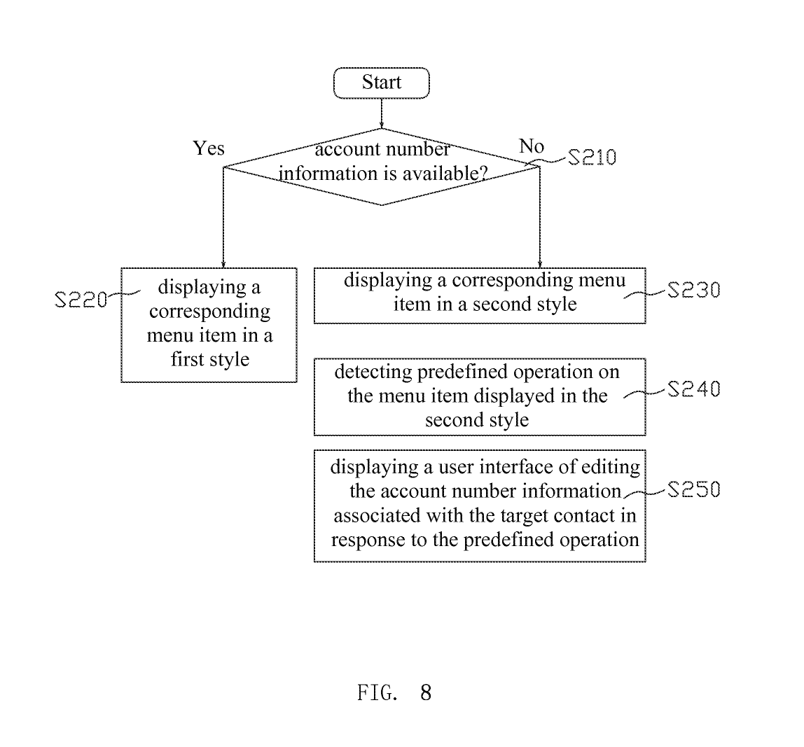

The second embodiment of the present disclosure provides a method for starting application in an electronic apparatus. The second embodiment is similar to the first embodiment; however, the different is that, referring to FIG. 8, Step 130 includes the following steps:

In step 210, for each menu item, the electronic apparatus detects whether account number information of the target contact associated with application corresponding to the menu item is available; if available, execute Step 220, otherwise execute Step 230. The preceding associated account number information may include, for example, telephone number, IM account, bank account, and any other possible account number information.

In step 220, the electronic apparatus displays a corresponding menu item in a first style.

In step 230, the electronic apparatus displays a corresponding menu item in a second style.

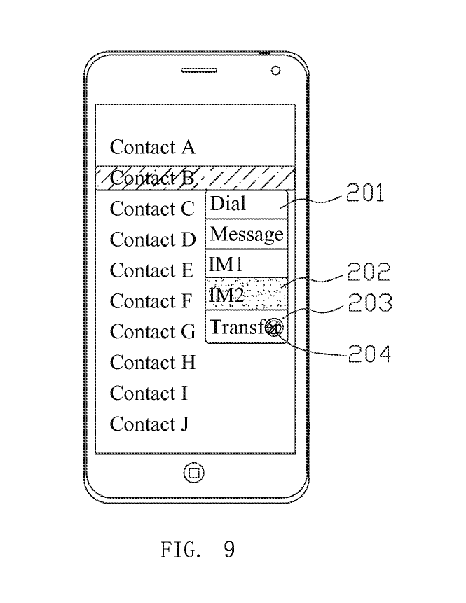

The first style and the second style are not limited specifically, but the both should be different, so that users may easily distinguish them. For example in the first style, the menu items use normal (for example, not bold, not gray, or not tilted) font, size, color or background image, etc. The second style may change one or more properties based on the first style. For example, as FIG. 9 illustrates, menu item 202 has a different background color/image; menu item 203 further contains an icon 204 at one side indicating the associated account number information unavailable. These differences may be used in combination.

When the menu item in a first style, such as menu item 201, is selected, step S150 is executed.

While for the menu item in a second style, the embodiment of the present disclosure further includes the following steps:

In step 240, the electronic apparatus detects predefined operation on the menu item displayed in the second style. The predefined operation is for example input by the input module 118 shown in FIG. 1. In detail, the operation may include any number of input mechanisms, such as keyboard, a gesture or graphical input based on touch-sensitive screen, voice commands, and so forth. The predefined operation may be different from the second input operation for distinction. For example, the predefined operation may be pressing menu item for longer than a predetermined time (for example, 2 seconds), or a specific gesture operation (such as sliding to the left or right).

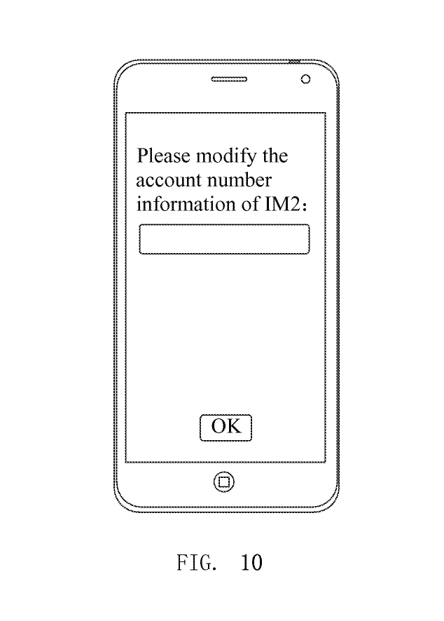

In step 250, the electronic apparatus displays a user interface of editing the account number information associated with the target contact in response to the predefined operation. As FIG. 10 shows, after detecting the predefined operation, the electronic apparatus triggers corresponding account number information editing function, users may modify the associated account number information of the target contact in the user interface shown in FIG. 10.

According to the method for starting application provided by the embodiment of the present disclosure, it is directly shown in the displayed operation menu that whether the associated account is available. Therefore the times of users' invalid operation is reduced.

### Third Embodiment

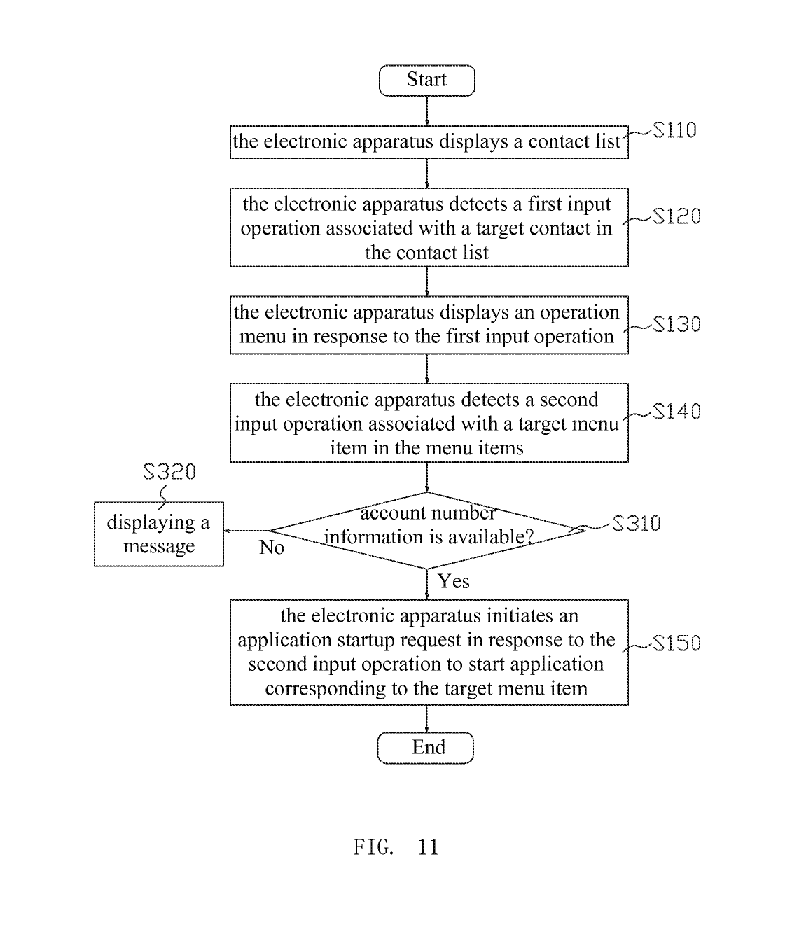

The third embodiment of the present disclosure provides a method for starting application in an electronic apparatus. The third embodiment is similar to the first embodiment, however, the different is, referring to FIG. 11, between step S140 and step S150 further including the following steps:

In Step 310, the electronic apparatus detects whether associated account number information of the target contact corresponding to the menu item is available; if available, execute step S150, otherwise execute Step 320.

In Step 320, the electronic apparatus displays a message.

For example, in the interface illustrated in FIG. 6, after the user clicks ‘transfer account’ on the touch-sensitive screen, the application detects whether the bank account number information of the target contact is available; if available, executes the transfer account application, that is, the interface shown in FIG. 7 appears. If unavailable, a message pops for prompting that due to lack of account number information, the application cannot perform the corresponding function, or requires the user to enter bank account number information.

According to the method provided by this embodiment of the present disclosure, when the associated account number information is unavailable, a message may pops in time for users knowing the progress better.

### Fourth Embodiment

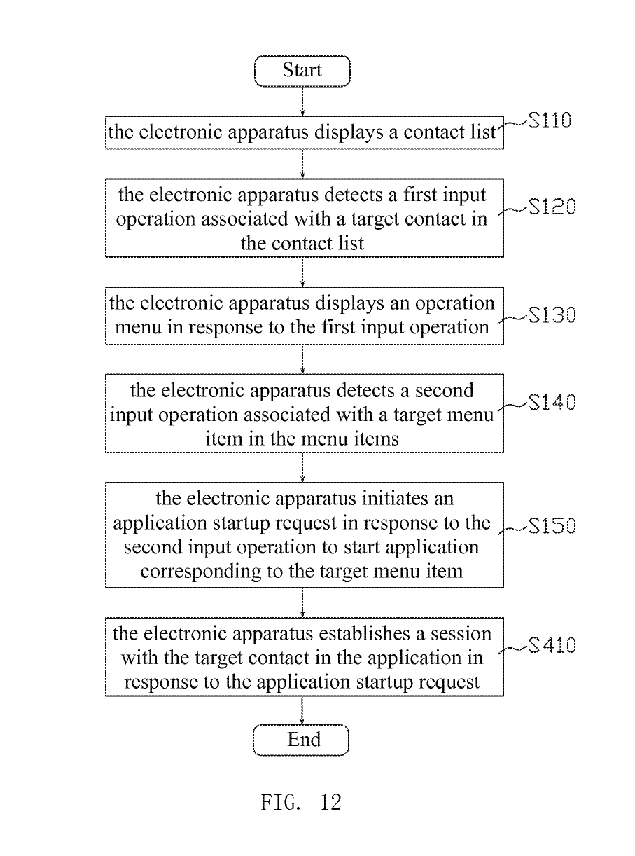

The fourth embodiment of the present disclosure provides a method for starting application in an electronic apparatus. The fourth embodiment is similar to the first embodiment; however, the different is that, referring to FIG. 12, after Step 150, further includes the following step: In Step 410, the electronic apparatus establishes a session with the target contact in the application in response to the application startup request.

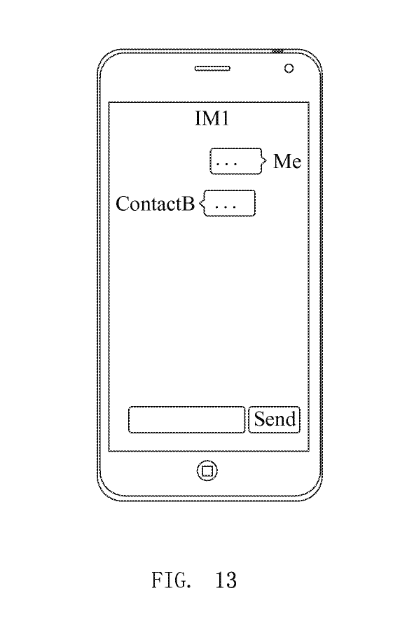

The application to be started, for example, is an Instant Messaging application. The session is user session in the Instant Messaging application. In the interface shown in FIG. 6, if the user touches the touch-sensitive screen to select the menu item “IM1”, the application starts the Instant Messaging application IM1, and the account number information (identification information) of the target contact in the Instant Messaging application IM1 is also contained in the startup request. Accordingly, the Instant Messaging application IM1 creates a session with the target contact, as shown in FIG. 13. The user may begin instant communication with the target contact in the interface shown in FIG. 13.

According to the method provided by this embodiment of the present disclosure, users may directly create an instant messaging session with the target contact by the contact list, thus the time for users finding out contact in the Instant Messaging application is reduced.

Furthermore, the application startup request may contain multiple account number information to create multiple sessions respectively, or create a group session. The group may include all account.

### Fifth Embodiment

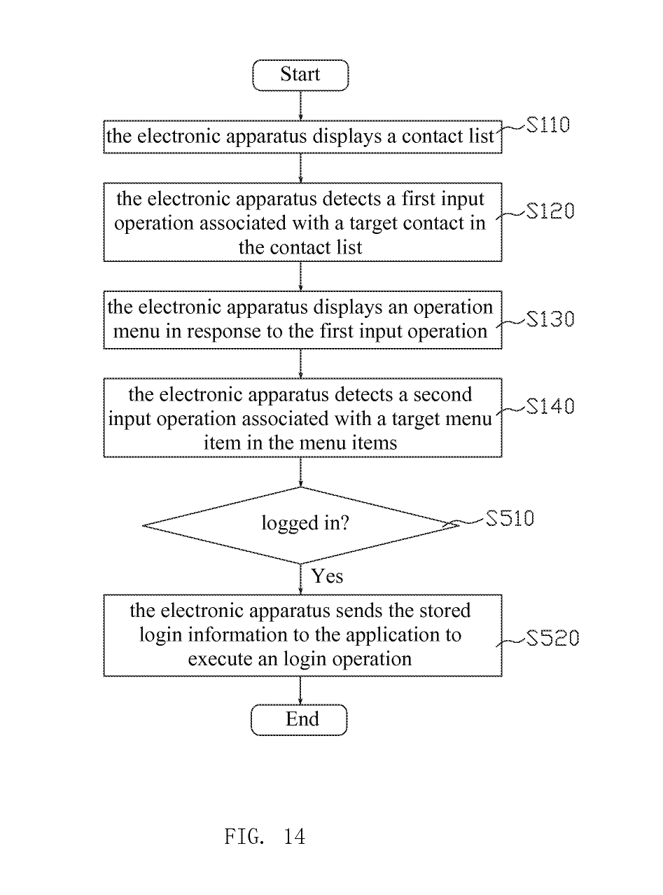

The fifth embodiment of the present disclosure provides a method for starting application in an electronic apparatus. The fifth embodiment is similar to the first embodiment, however, the different is, referring to FIG. 14, after Step 140, further including following steps:

In Step 510, the electronic apparatus detects whether the application corresponding to the target menu item needs to be logged in; if needs, executes Step 520, otherwise executes Step 150 (FIG. 2).

In Step 520, the electronic apparatus sends the stored login information to the application to execute a login operation.

For example, in the user interface shown in FIG. 6, if the user selects the menu item “IM1” on the touch screen, and the Instant Messaging application “IM1” needs login operation according to the record, the login information (user name and password for example) will be sent to the Instant Messaging application “IM1” to perform login operation. Understandably, it is necessary for the instant messaging application “IM1” to open the interface of performing login operation to the application. After authentication, the application may further send the account number information of the target contact to the Instant Messaging application IM1 to establish a corresponding session as shown in FIG. 13.

According to the method provided by this embodiment of the present disclosure, the application is automatically landed; therefore the time of users entering user name and password is further saved.

What's more, various methods provided by the embodiments of the disclosure discussed above is done for illustration purposes only, and should not be taken as limitations of the general principles of the method for starting application in electronic apparatus provided by the embodiment of the disclosure. It will be understood that various combinations and changes in the form and details of the method illustrated may be made by those skilled in the art without departing from the disclosure.

### Sixth Embodiment

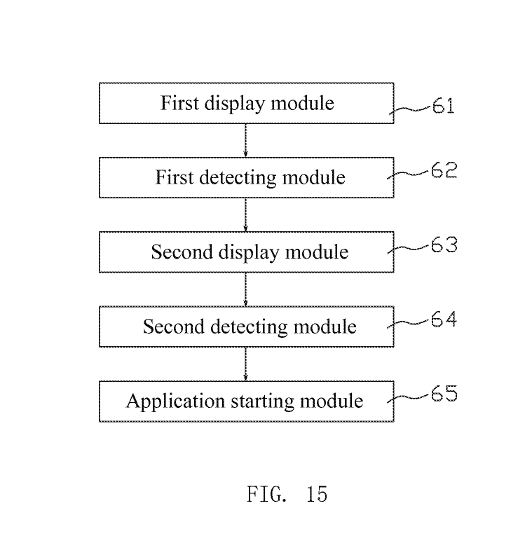

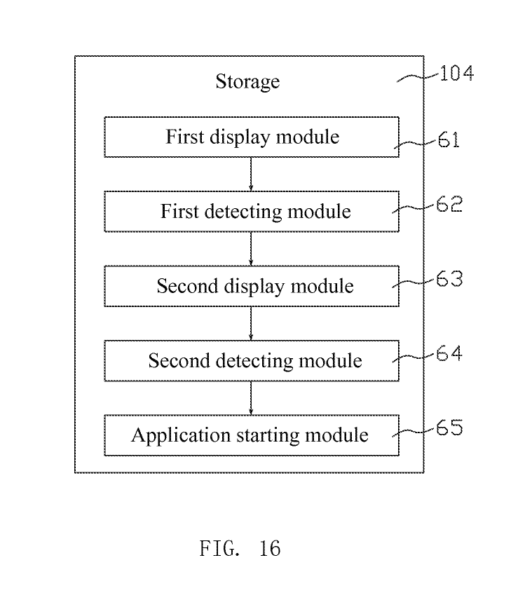

The sixth embodiment of the present disclosure provides a device for starting application in an electronic apparatus. Referring to FIG. 15, the device includes a first display module 61, a first detecting module 62, a second display module 63, a second detecting module 64, and application starting module 65. The preceding modules may store in the storage 104, as shown in FIG. 16.

The first display module 61 is configured to display a contact list. Contact information may be stored in the storage unit 104 as FIG. 1 shows. Each contact information may include, for example, phone number(s), a name, address(es), instant messaging application account, bank account, or other possible information associated with the contact. The contact list may show one or more of these fields. FIG. 3 illustrates an example of a contact list, wherein the contact list shows contact names. In the contact list shown in FIG. 3, each item represents one contact.

The first detecting module 62 is configured to detect a first input operation associated with a target contact in the contact list. The first input operation for example is input via the input module shown in FIG. 1. In detail, the operation may include any number of input mechanisms, such as keyboard, a gesture or graphical input based on touch-sensitive screen, voice commands, and so forth. FIG. 4 illustrates a gesture input based on touch-sensitive screen, that is, users may use an object (such as a finger) to touch the menu item where “contact B” locates. The preceding touch operation is received by the input unit 118. The input unit 118 calculates coordinate of the contact and transfers the coordinate to the processor 102. During the process, the touch operation triggers a click invent.

The second display module 63 is configured to display an operation menu in response to the first input operation. The operation menu includes a plurality of menu items. Each menu item corresponds to one or more application. Referring to FIG. 5, the operation menu includes a plurality of menu items. Their names are “make call”, “send message”, “IM 1”, “IM 2”, and “transfer account”. These names illustrate their functions. Each item is corresponding to one or more application.

The second detecting module 64 is configured to detect a second input operation associated with a target menu item in the menu items. The second input operation for example is input via the input module shown in FIG. 1. In detail, the operation may include any number of input mechanisms, such as keyboard, a gesture or graphical input based on touch-sensitive screen, voice commands, and so forth. FIG. 6 illustrates a gesture input based on touch-sensitive screen, that is, users may use an object (such as a finger) to touch the menu item where “Transfer” locates. The preceding touch operation (the second input operation) is received by the input unit 118. The input unit 118 calculates coordinate of the contact and transfers the coordinate to the processor 102. During the process, the touch operation triggers a click invent.

The application starting module 65 is configured to initiate an application startup request in response to the second input operation to start application corresponding to the target menu item. The application startup request includes information of the target contact.

According to the device for starting application provided by the embodiment of the present disclosure, users may directly start different application in a contact list, and transfer selected contact information to the application to be started. Therefore, the application to be started may be automatically configured according to the selected contact information, which reduces user operation and saves time for users.

### Seventh Embodiment

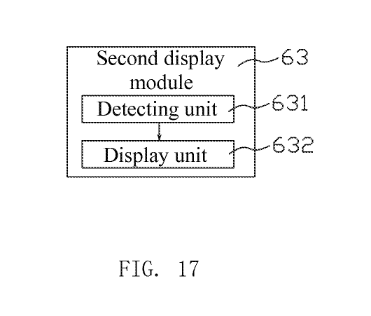

The seventh embodiment of the present disclosure provides a device for starting application in an electronic apparatus. The seventh embodiment is similar to the sixth embodiment; however, the different is that, referring to FIG. 17, the second display module 63 includes: a detecting unit 631 and a display unit 632.

For each menu item, the detecting unit 631 is configured to detect whether account number information of the target contact associated with application corresponding to the menu item is available.

If the result of the detecting unit 631 is yes, the display unit 632 is configured to display a corresponding menu item in a first style, otherwise display a corresponding menu item in a second style.

For clarity, other details of the detecting unit 631 and the display unit 632 may refer to the second embodiment.

According to the device for starting application provided by the embodiment of the present disclosure, it is directly shown in the displayed operation menu that whether the associated account is available. Therefore the times of users' invalid operation is reduced.

### Eighth Embodiment

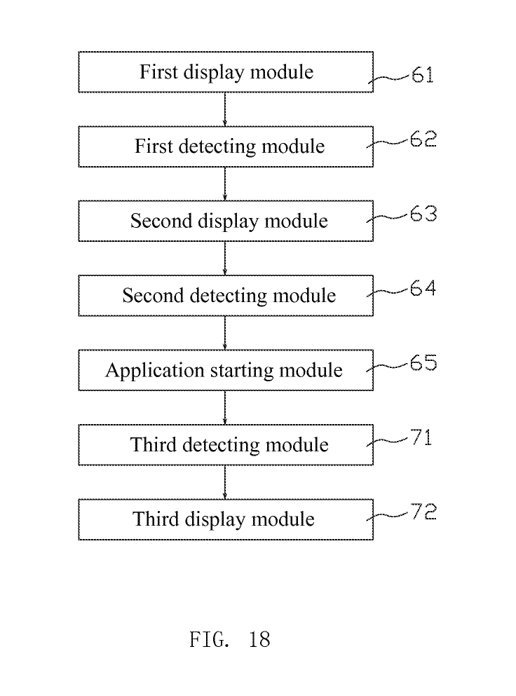

The eighth embodiment of the present disclosure provides a device for starting application in an electronic apparatus. The eighth embodiment is similar to the sixth embodiment; however, the different is that, referring to FIG. 18, the device further includes: a third detecting module 71 and a third display module 72.

The third detecting module 71 is configured to detect predefined operation on the menu item displayed in the second style. The third display module 72 is configured to display a user interface of editing the account number information associated with the target contact in response to the predefined operation.

The predefined operation is for example input by the input module 118 shown in FIG. 1. In detail, the operation may include any number of input mechanisms, such as keyboard, a gesture or graphical input based on touch-sensitive screen, voice commands, and so forth. The predefined operation may be different from the second input operation for distinction. For example, the predefined operation may be pressing menu item for longer than a predetermined time (for example, 2 seconds), or a specific gesture operation (such as sliding to the left or right).

Referring to FIG. 10, after detecting the predefined operation, the corresponding account number information editing function is triggered. Users may modify the associated account number information of the target contact in the interface shown in FIG. 10.

According to the device for starting application provided by the embodiment of the present disclosure, the associated account number information corresponding to the menu item can be modified.

### Ninth Embodiment

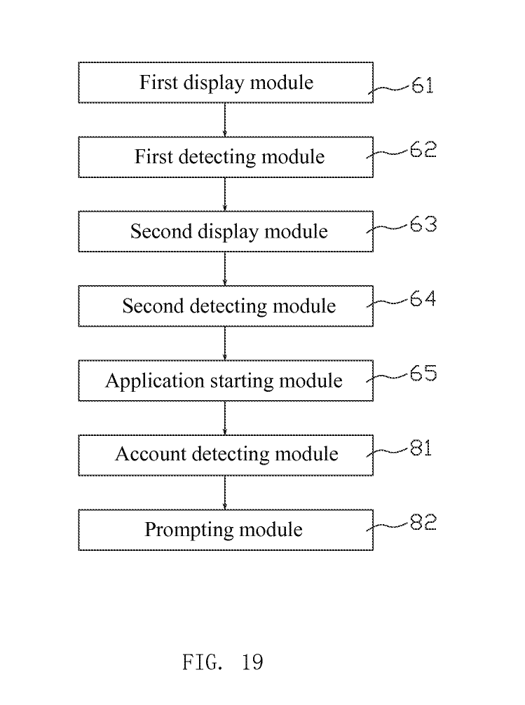

The ninth embodiment of the present disclosure provides a device for starting application in an electronic apparatus. The ninth embodiment is similar to the sixth embodiment; however, the different is that, referring to FIG. 19, the device further including: an account detecting module 81 and a prompting module 82.

The account detecting module is configured to detect whether the associated account number information of the target contact corresponding to the menu item is available; if the result of the account detecting module is yes, the application starting module 65 initiates the application startup request; otherwise the prompting module 82 shows a message.

In the interface illustrated in FIG. 6, after the user clicks ‘transfer account’ on the touch-sensitive screen, the application detects whether the bank account number information of the target contact is available; if available, executes the transfer account application, that is, the interface shown in FIG. 7 appears. If unavailable, a message pops for prompting that due to lack of account number information, the application cannot perform the corresponding function, or requires the user to enter bank account number information.

According to the device provided by this embodiment of the present disclosure, when the associated account number information is unavailable, a message may pops in time for users knowing the progress better.

### Tenth Embodiment

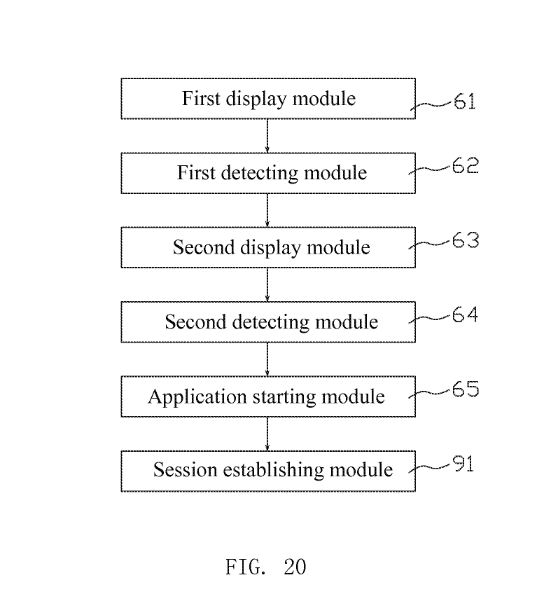

The tenth embodiment of the present disclosure provides a device for starting application in an electronic apparatus. The tenth embodiment is similar to the sixth embodiment; however, the different is that, referring to FIG. 20, the device further includes a session establishing module 91.

The session establishing module 91 is configured to establish a session with the target contact in the application in response to the application startup request.

The application to be started, for example, is an Instant Messaging application. The session is user session in the Instant Messaging application. In the interface shown in FIG. 6, if the user touches the touch-sensitive screen to select the menu item “IM1”, the application starts the Instant Messaging application IM1, and the account number information (identification information) of the target contact in the Instant Messaging application IM1 is also contained in the startup request. Accordingly, the Instant Messaging application IM1 creates a session with the target contact, as shown in FIG. 13. The user may begin instant communication with the target contact in the interface shown in FIG. 13.

According to the device provided by this embodiment of the present disclosure, users may directly create an instant messaging session with the target contact by the contact list, thus the time for users finding out contact in the Instant Messaging application is reduced.

### Eleventh Embodiment

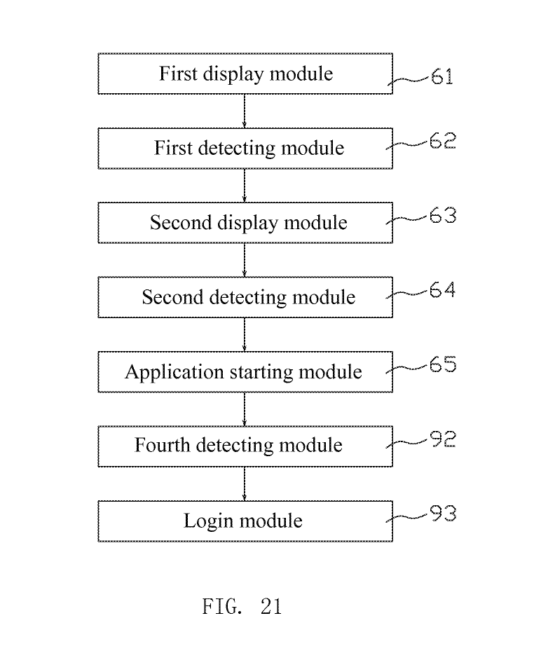

The eleventh embodiment of the present disclosure provides a device for starting application in an electronic apparatus. The eleventh embodiment is similar to the sixth embodiment; however, the different is that, referring to FIG. 21, the device further includes: a fourth detecting module 92 and login module 93.

The fourth detecting module 92 is configured to detect whether the application corresponding to the target menu item needs to be logged in; if the result of the fourth detecting module is yes, the login module 93 sends the stored login information to the application to execute login operation.

For example, in the user interface shown in FIG. 6, if the user selects the menu item “IM1” on the touch screen, and the Instant Messaging application “IM1” needs login operation according to the record, the login information (user name and password for example) will be sent to the Instant Messaging application “IM1” to perform login operation. Understandably, it is necessary for the instant messaging application “IM1” to open the interface of performing login operation to the application. After authentication, the application may further send the account number information of the target contact to the Instant Messaging application IM1 to establish a corresponding session as shown in FIG. 13.

According to the device provided by this embodiment of the present disclosure, the application is automatically landed; therefore the time of users entering user name and password is further saved.

What's more, various devices provided by the embodiments of the disclosure discussed above is done for illustration purposes only, and should not be taken as limitations of the general principles of the device for starting application in electronic apparatus provided by the embodiment of the disclosure. It will be understood that various combinations and changes in the form and details of the device illustrated may be made by those skilled in the art without departing from the disclosure.

Embodiments within the scope of the present disclosure may also include computer-readable media for carrying or having computer-executable instructions or data structures stored thereon. Such computer-readable media may be any available media that is accessed by a general purpose or special purpose computer. By way of example, and not limitation, such computer-readable media may include RAM, ROM, EEPROM, CD-ROM or other optical disk storage, magnetic disk storage or other magnetic storage devices, or any other medium which may be used to carry or store desired program code means in the form of computer-executable instructions or data structures. When information is transferred or provided over a network or another communications connection (either hardwired, wireless, or combination thereof) to a computer, the computer properly views the connection as a computer-readable medium. A “tangible” computer-readable medium expressly excludes software per se (not stored on a tangible medium) and a wireless, air interface. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

The sequence numbers of the above embodiments of the disclosure are only for the purpose of description, and do not represent one embodiment is superior to another.

The above descriptions are only preferred embodiments of the present disclosure, and are not intended to limit the present disclosure. Any amendments, replacement and modification made to the above embodiments under the spirit and principle of the present disclosure should be included in the scope of the present disclosure.

What is claimed is:

1. A method for starting an application in an electronic apparatus, the method comprising:
displaying a contact list;
detecting a first input operation associated with a target contact in the contact list;
in response to the first input operation, displaying an operation menu, the operation menu comprising a plurality of menu items, each menu item corresponding to at least one application;
detecting a second input operation associated with a target menu item in the menu items; and
in response to the second input operation, initiating an application startup request to start application corresponding to the target menu item, wherein the application startup request includes information of the target contact.

2. The method as claimed in claim 1, wherein the step of displaying an operation menu comprises:
for each menu item, detecting whether account number information of the target contact, associated with the application corresponding to the menu item, is available; and
if available, displaying the corresponding menu item in a first style, otherwise displaying the corresponding menu item in a second style.

3. The method as claimed in claim 2, wherein the second style comprises:
the menu item containing an icon at one side thereof indicating that the associated account number information is unavailable.

4. The method as claimed in claim 2, further comprising:
detecting predefined operation on the menu item displayed in the second style; and
in response to the predefined operation, displaying a user interface for editing the account number information associated with the target contact.

5. The method as claimed in claim 1, further comprising:
detecting whether associated account number information of the target contact corresponding to the menu item is available; and
if available, initiating the application startup request; otherwise showing a message.

6. The method as claimed in claim 1, further comprising:
in response to the application startup request, establishing a session with the target contact in the application.

7. The method as claimed in claim 1, further comprising:
detecting whether the application corresponding to the target menu item needs to be logged in; and
if the application needs to be logged in, sending the stored login information to the application to execute an login operation.

8. A device for starting an application in an electronic apparatus, wherein the device comprises at least a processor operating in conjunction with a memory and a plurality of modules, the plurality of modules comprises:
a first display module, configured to display a contact list;
a first detecting module, configured to detect a first input operation associated with a target contact in the contact list;
a second display module, configured to display an operation menu in response to the first input operation, the operation menu comprising a plurality of menu items, each menu item corresponding to at least one application;
a second detecting module, configured to detect a second input operation associated with a target menu item in the menu items; and
an application startup module, configured to initiate an application startup request in response to the second input operation to start application corresponding to the target menu item, wherein the application startup request includes information of the target contact.

9. The device as claimed in claim 8, wherein the second display module comprises:
a detecting unit, for each menu item, configured to detect whether account number information of the target contact, associated with the application corresponding to the menu item, is available; and
a display unit, if the result of the detecting unit is yes, configured to display the corresponding menu item in a first style, otherwise display the corresponding menu item in a second style.

10. The device as claimed in claim 9, wherein the second style comprises:
the menu item containing an icon at one side thereof indicating that the associated account number information is unavailable.

11. The device as claimed in claim 9, further comprising:
a third detecting module, configured to detect predefined operation on the menu item displayed in the second style; and
a third display module, configured to display a user interface for editing the account number information associated with the target contact, in response to the predefined operation.

12. The device as claimed in claim 8, further comprising:
an account detecting module, configured to detect whether associated account number information of the target contact corresponding to the menu item is available; if the result of the account detecting module is yes, the application starting module initiates the application startup request; and
a prompt module, configured to show a message if the result of the account detecting module is no.

13. The device as claimed in claim 8, further comprising a session establishing module, configured to establish a session with the target contact in the application in response to the application startup request.

14. The device as claimed in claim 8, further comprising:
a fourth detecting module, configured to detect whether the application corresponding to the target menu item needs to be logged in; and
a login module, configured to send the stored login information to the application to execute an login operation if the result of the fourth detecting module is yes.

15. A non-transitory computer-readable storage medium storing instructions for starting an application in an electronic apparatus, the instructions comprising:
displaying a contact list;
detecting a first input operation associated with a target contact in the contact list;
in response to the first input operation, displaying an operation menu, the operation menu comprising a plurality of menu items, each menu item corresponding to at least one application;
detecting a second input operation associated with a target menu item in the menu items; and
in response to the second input operation, initiating an application startup request to start application corresponding to the target menu item, wherein the application startup request includes information of the target contact.

16. The non-transitory computer-readable storage medium as claimed in claim 15, wherein the step of displaying an operation menu comprises:
for each menu item, detecting whether account number information of the target contact, associated with the application corresponding to the menu item, is available; and
if available, displaying the corresponding menu item in a first style, otherwise displaying the corresponding menu item in a second style.

17. The non-transitory computer-readable storage medium as claimed in claim 16, wherein the second style comprises:
the menu item containing an icon at one side thereof indicating that the associated account number information is unavailable.

18. The non-transitory computer-readable storage medium as claimed in claim 16, further comprising:
detecting predefined operation on the menu item displayed in the second style; and
in response to the predefined operation, displaying a user interface for editing the account number information associated with the target contact.

19. The non-transitory computer-readable storage medium as claimed in claim 15, further comprising:
detecting whether associated account number information of the target contact corresponding to the menu item is available; and
if available, initiating the application startup request; otherwise showing a message.

20. The non-transitory computer-readable storage medium as claimed in claim 15, further comprising:
in response to the application startup request, establishing a session with the target contact in the application.

21. The non-transitory computer-readable storage medium as claimed in claim 15, further comprising:
detecting whether the application corresponding to the target menu item needs to be logged in; and
if the application needs to be logged in, sending the stored login information to the application to execute an login operation.
